(19) United States
(12) Patent Application Publication
(10) Pub. No.: US 2010/0143593 A1
(43) Pub. Date: Jun. 10, 2010

(54) IMAGE RECORDING METHOD, RECORDED MATTER, AND IMAGE RECORDING SYSTEM

(75) Inventor: Tsuyoshi SANO, Shiojiri-shi (JP)

Correspondence Address: LADAS & PARRY LLP, 26 WEST 61ST STREET, NEW YORK, NY, 10023, US

(73) Assignee: SEIKO EPSON CORPORATION

(21) Appl. No.: 12/633,829

(22) Filed: Dec. 9, 2009

(30) Foreign Application Priority Data
Dec. 9, 2008 (JP) 2008-312994
Nov. 9, 2009 (JP) 2009-255790

(51) Int. Cl. B05D 1/38; B05C 5/00

(52) U.S. Cl. 427/265; 118/300

(57) ABSTRACT

An image recording method includes forming an undercoat layer of an undercoat-forming ink composition containing a volatile component on a medium, and forming a color image layer of a process color ink composition on the undercoat layer in a state where the content of the volatile component remaining in the undercoat layer is 5% to 50% by mass.

### BACKGROUND

1. Technical Field

The present invention relates to an image recording method that can prevent bleeding and thus provide high-quality images, and to a recorded matter produced by the method. The present invention also relates to an image recording system that can prevent bleeding and thus provide high-quality images.

2. Related Art

For printing color images on recording paper or the like, the ink jet method is often employed. On the other hand, for printing a color pattern on a medium whose base color may not be white, such as a plastic medium or a metallic medium, ink is applied to a considerably large thickness to prevent the resulting pattern from being affected by the base color.

In order to provide a method for producing a color printed matter, suitable to form a color pattern or letters on a medium whose base color may not be white, JP-A-2000-141708 discloses a technique in which a white undercoat layer is formed on the print surface of the medium and color inks are then ejected onto the undercoat layer from a recording head.

In the known art, however, when an image is formed of process color inks after forming the undercoat layer, the resulting color image is liable to cause bleeding. It has been difficult to achieve a satisfying image quality.

Japanese Patent No. 4059629 discloses a method for performing ink jet printing on a non-absorbent substrate. This method includes forming a wet colorless or white undercoating on a non-absorbent substrate, forming a pattern with wet ink droplets before the wet undercoating is dried, and drying the undercoating and the pattern of the ink droplets. In this method, the thickness of the undercoating is locally varied according to the ink droplet pattern to be formed by controlling the number of applied ink droplets in inverse proportion to the thickness. A UV-curable or hot-melt undercoat material or ink is used for the wet undercoat layer and the wet ink droplets.

This document, however, does not disclose or suggest the relationship between the volatile component remaining in the undercoat layer and the bleeding in the color image formed on the undercoat layer.

### SUMMARY

Accordingly, an advantage of some aspects of the invention is that it provides an image recording method that can prevent bleeding and thus provide high-quality images.

Another advantage of some aspects of the invention is that it provides an image recording system that can prevent bleeding and thus provide high-quality images.

The present inventors found that when an undercoat layer and a color image layer are formed on a non-absorbent or low-absorbent medium, the bleeding in the color image depends on the volatile component remaining in the undercoat layer. It has been also found that the bleeding in a color image can occur even though the color image is formed after the entire volatile component has substantially been vaporized (that is, after the undercoat layer has substantially been dried).

According to an aspect of the invention, an image recording method is provided which include forming an undercoat layer of an undercoat-forming ink composition containing a volatile component on a medium, and forming a color image layer of a process color ink composition on the undercoat layer in a state where the content of the volatile component remaining in the undercoat layer is 5% to 50% by mass.

The image recording method may further include drying the undercoat layer between forming the undercoat layer and forming the color image layer.

The undercoat layer-forming ink composition may be a brilliant ink composition containing a metallic pigment or a white ink composition containing a white color material selected from among metal compounds and hollow resin particles.

The undercoat layer-forming ink composition and the process color ink composition may contain water as the main solvent.

The undercoat layer-forming ink composition may contain 3% to 20% by mass of solid content.

The color image layer may be formed on the undercoat layer in a state where the content of the remaining volatile component is 10% to 25% by mass.

The image recording method may further include drying the undercoat layer and the color image layer after forming the color image layer.

The medium may be made of an ink-non-absorbent or ink-low-absorbent material.

The image recording method may be performed by a recording apparatus including a recording head including a nozzle line defined by a plurality of nozzles, and a transport member that transports the medium in a sub-scanning direction intersecting a main scanning direction. The undercoat layer-forming ink composition and the process color ink composition are ejected onto the medium from the recording head in a state where the recording head opposes the medium, and the recording head ejects the process color ink composition onto the medium a predetermined time after the undercoat layer-forming ink composition is ejected.

The undercoat layer-forming ink composition may be ejected more upstream than the process color ink composition in the direction in which the medium is transported.

The recording apparatus may further include a carriage that has the recording head thereon and reciprocally moves in the main scanning direction. The undercoat layer-forming ink composition is ejected from the recording head onto the base material stopped being transported while the carriage is reciprocally moving, and then the process color ink composition is ejected from the recording head onto the base material while the carriage is reciprocally moving.

The recording apparatus may further include a heater that heats the base material. The base material is heated after forming the undercoat layer.

The image recording method is performed by an ink jet recording method.

According to another aspect of the invention, a recorded matter produced by the image recording method is provided.

According to still another aspect of the invention, a image recording system is provided which includes an undercoat layer-forming unit that forms an undercoat layer of an undercoat-forming ink composition containing a volatile component on a base material, and a color image layer-forming unit that forms an color image layer of a process color ink composition on the undercoat layer in a state where the content of the volatile component remaining in the undercoat layer is 5% to 50% by mass.

The image recording method can produce high-quality images in which bleeding does not easily occur.

### BRIEF DESCRIPTION OF THE DRAWINGS

The invention will be described with reference to the accompanying drawings, wherein like numbers reference like elements.

FIG. 1 is a schematic fragmentary view of an evaluation test apparatus used in Printing Test 2.

FIG. 2 is a schematic diagram illustrating the relationship between the nozzle liens arranged in a recording head and the scanning in Printing Test 2.

FIGS. 3A to 3D are schematic diagrams illustrating steps of the image recording method used in Printing Test 3.

FIG. 4 is a schematic diagram illustrating the relationship between the nozzle liens arranged in a recording head and the scanning in Printing Test 3.

FIG. 5 is a plot of drying temperature curves with the remaining volatile content and drying time.

### DESCRIPTION OF EXEMPLARY EMBODIMENTS

### Image Recording Method

An image recording method according to an embodiment of the invention includes forming an undercoat layer of an undercoat-forming ink composition on a medium (first step), and forming a color image layer of a process color ink composition on the undercoat layer in a state where the undercoat layer contains 5% to 50% by mass of remaining volatile component (second step).

The content of remaining volatile component (often referred to as remaining volatile content) mentioned herein is calculated by subtracting the amount of vaporized component from the initial content of volatile component in the undercoat layer-forming ink composition. The volatile component refers to the constituents other than the solid constituents in the ink composition. The volatile component in an ink composition generally contains a solvent (organic solvent or water) and volatile organic additives (may be water-soluble organic substances when the solvent is water). The solid constituents in an ink composition generally include a color material, such as pigment, a dispersant resin, an additive resin, such as a leveling agent, and a surfactant.

The remaining volatile content can be calculated from the weight of the ink composition of the image formed on a print surface.

If a color image is formed of the process color ink composition on the undercoat layer in a state where the content of the volatile component remaining in the undercoat layer is more than 50% by mass, notable bleeding may occur in the color image because the undercoat layer is excessively wet. On the other hand, if the color image is formed of the process color ink composition on the undercoat layer in a state where the remaining volatile content is reduced to less than 5% by mass in the undercoat layer, notable bleeding may occur in the color image as well even though the volatile component has substantially vaporized. Preferably, the remaining volatile content is 8% to 40% by mass, more preferably 10% to 25% by mass.

An image recording method according to an embodiment of the invention will now be described in detail.

### 1. Undercoat Layer-Forming Ink Composition

First, the undercoat layer-forming ink composition used in the present embodiment of the invention will be described. The undercoat layer-forming ink composition is not particularly limited, and is, preferably, a brilliant ink composition containing a metallic pigment or a white ink composition containing a white color material, such as a metal compound or hollow resin particles.

The solid content in the undercoat layer-forming ink composition is preferably 3% to 20% by mass, more preferably 5% to 15% by mass, in view of effectiveness.

Preferably, the undercoat layer-forming ink composition and the process color ink composition for forming an image layer on the undercoat layer each contain water as a main solvent. The vaporization of water is easy to control, and the use of water as the solvent allows easy design of the resin added to the ink composition to form a coating on the surface of a recording medium. In addition, since the volatile component is water (steam) in this instance, a special ventilation is not required and the ventilation can be simple.

The brilliant ink composition and the white ink composition will be described below.

### 1-1. Brilliant Ink Composition

The brilliant ink composition used in the present embodiment of the invention contains a metallic pigment. The metallic pigment contains flat particles. Preferably, the flat particles have a 50% average circle-equivalent particle size R50 of 0.3 to 5 μm and satisfy R50/Z>5. The R50 of flat particles having a long diameter X, a short diameter Y, and a thickness Z is calculated from the area of the X-Y plane of the flat particles.

The flat particle refers to a particle having a substantially even surface (X-Y plane) and a substantially uniform thickness (Z). The flat particles having g a substantially even surface and a substantially uniform thickness can be prepared by pulverizing a deposited metal film. The particle size of such particles can be defined by the long diameter X, the short diameter Y, and the thickness Z.

The circle-equivalent diameter is the diameter of a circle whose projected area is equivalent to the projected area of the substantially even X-Y plane of the flat particle of the metallic pigment. For example, if the X-Y plane of the flat particle of the metallic pigment is polygonal, the projected plane of the polygonal X-Y plane is converted into a circle, and the diameter of the circle is defined as the circle-equivalent diameter of the flat particle of the metallic pigment.

The 50% average particle size R50 obtained from the X-Y plane area of the flat particles is preferably 0.5 to 3 μm, more preferably 0.75 to 2 μm in view of the brilliance and the printing stability.

The 50% average particle size R50 in terms of circle-equivalent diameter and the thickness Z satisfy the relationship R50/Z>5 from the viewpoint of ensuring a high brilliance.

Preferably, the metallic pigment contains aluminum or an aluminum alloy from the viewpoint of cost efficiency and ensuring a high brilliance. If an aluminum alloy is used, the counterpart of aluminum may be a metallic element or a non-metallic element without particular limitation as long as it is brilliant. Exemplary counterparts include silver, gold, platinum, nickel, chromium, tin, zinc, indium, titanium, and copper. These elements may be used singly or in combination.

The metallic pigment can be prepared as below. For example, a composite pigment material is prepared by forming a releasing resin layer and a metal or alloy layer in that order on the surface of a base sheet. The metal or alloy layer is separated from the base sheet at the interface with the releasing resin layer, and is then pulverized into flat particles. The flat particles are classified to select particles having an R50 of 0.5 to 3 μm and satisfying the relationship R50/Z>5. The R50 of flat particles is calculated from the area of the X-Y plane of the flat particles. X represents long diameter of the flat particle; Y, the short diameter; and Z, the thickness Z.

The long diameter X, the short diameter Y and the circle-equivalent diameter of the metallic pigment (flat particles) can be measured with a particle image analyzer. For example, a flow particle image analyzer FPIA-2100, FPIA-3000 or FPIA-3000S (manufactured by Sysmex) may be used as the particle image analyzer.

The metal or alloy layer can be formed by vacuum vapor deposition, ion plating, or sputtering.

The metal or alloy layer has a thickness of 20 to 100 nm. Thus, the particles of the resulting pigment have an average thickness of 20 to 100 nm. By setting the thickness to 20 nm or more, the reflectivity and the brilliance of the pigment cam be increased to enhance the performance of the metallic pigment. By setting the thickness to 100 nm or less, the apparent specific gravity of the pigment can be reduced to ensure a dispersion stability of the pigment.

The releasing resin layer of the composite pigment material doubles as the undercoat layer of the metal or alloy layer and the releasing layer for making it easy to separate the metal or alloy layer from the base sheet. The releasing resin layer is preferably made of, for example, polyvinyl alcohol, polyvinyl butyral, polyethylene glycol, polyacrylic acid, polyacrylamide, cellulose derivatives, polyvinyl butyral, acrylic acid polymer, and modified nylon resin.

A solution of at least one of these resins is applied onto a recording medium and dried, thus forming the releasing resin layer. An additive, such as a viscosity adjuster, may be added to the solution.

For applying the resin solution to form the releasing resin layer, a conventional method can be used, such as gravure coating, roll coating, blade coating, extrusion coating, dip coating, or spin coating. After application and drying, the surface of the releasing resin layer may be planarized by calendaring if necessary.

The thickness of the releasing resin layer is not particularly limited, but is preferably 0.5 to 50 μm, more preferably 1 to 10 μm. If the thickness is less than 0.5 μm, the amount of resin to be dispersed becomes insufficient. If the thickness is more than 50 μm, the metal or alloy layer is likely to separate at the interface when the composite pigment material is rolled.

Exemplary materials of the base sheet include, but not limited to, polyesters, such as polytetrafluoroethylene, polyethylene, polypropylene, and polyethylene terephthalate; polyamides, such as 66-nylon and 6-nylon; and releasable resins, such as polycarbonate, triacetate, and polyimide. Among those, preferred are polyethylene terephthalate and its copolymers.

Thickness of the base sheet is not particularly limited, but is preferably 10 to 150 μm. A base sheet having a thickness of 10 μm or more does not have a problem with handling in the manufacturing process. A base sheet having a thickness of 150 μm or less is so flexible as not to have problems with rolling and separation.

The metal or alloy layer may be disposed between protective layers as disclosed in JP-A-2005-68250. The protective layers can be made of silicon oxide or a protective resin.

If the protective layer is made of silicon oxide, the silicon oxide layer is not particularly limited as long as it contains silicon oxide. Preferably, the silicon oxide protective layer is formed of a silicon alkoxide, such as tetraalkoxysilane, or its polymer by a sol-gel method.

More specifically, a solution containing silicon alkoxide or its polymer in an alcohol is applied and heated to form a silicon oxide coating.

The material of the protective layer is not particularly limited as long as the resin is insoluble in a disperse media. Exemplary materials for the protective resins include polyvinyl alcohol, polyethylene glycol, polyacrylic acid, polyacrylamide, and cellulose derivatives. Among those preferred are polyvinyl alcohol and cellulose derivatives.

More specifically, an aqueous solution containing at least one of those resins is applied and dried to form a resin coating. An additive, such as a viscosity adjuster, may be added to the aqueous solution.

For applying silicon oxide or protective resin, the same method as in the formation of the releasing resin layer may be used.

The thickness of the protective layer is not particularly limited, but is preferably 50 to 150 nm. A protective layer having a thickness of less than 50 nm may not have a sufficient mechanical strength. A protective layer having a thickness of more than 150 nm may be excessively strong and difficult to pulverize and disperse, and in addition, may cause separation at the interface with the metal or alloy layer.

A color material layer may be provided between the protective layer and the metal or alloy layer.

The color material layer is intended to impart a desired color to the pigment, and may contain any color material as long as it can impart an intended color and hue to the brilliant metallic pigment. The color material may be a dye or a pigment. The dye or pigment can be appropriately selected from known materials.

The pigment used for the color material layer refers to the pigment defined in the field of general pigment chemistry, including natural pigment, synthetic organic pigment and synthetic inorganic pigment, and is different from the composite pigment having a multilayer structure used in the present embodiment of the invention.

The color material layer may be formed by, but not limited to, coating.

If a pigment is used as the color material of the color material layer, it is preferable that the color material layer contain a resin for dispersing the color material. Preferably, the color material-dispersing resin is mixed with the pigment and optionally additives, and the mixture is dispersed or dissolved in a solvent. The dispersion or solution is applied and dried to form a uniform coating, and thus, a resin thin film is formed as the color material layer.

It is preferable that both the color material layer and the protective layers be formed by coating in terms of work efficiency in the process for preparing the composite pigment material.

The composite pigment material may have a multilayer structure including alternately disposed releasing resin layers and metal or alloy layers. In this instance, the total thickness of the multilayer structure, that is, the thickness of the entire multilayer structure not including the base sheet or the releasing resin layer in contact with the base sheet, is preferably 5000 nm or less. Such a thickness allows the composite pigment material to be rolled without cracks or separation and thus to be superior in storage stability. Also, the resulting pigment exhibits superior brilliance.

The composite pigment material may have a structure in which the multilayer structure including the releasing resin layer and the metal or alloy layer is disposed on both surfaces of the base sheet.

For separating the multilayer structure from the base sheet, for example, the resulting composite pigment material may be immersed in a liquid, or may be subjected to ultrasonic treatment in a liquid. The separated pigment material is pulverized into particles of the pigment.

The releasing resin layer of the resulting pigment acts as protective colloid, and thus allows a stable dispersion to be prepared by only dispersing the pigment in a solvent. In the ink composition containing the pigment, the resin of the releasing resin layer functions to enhance the adhesion of the ink composition to the recording medium, such as paper.

The brilliant ink composition used in the present embodiment of the invention is prepared by dispersing the metallic pigment in a solvent. The main solvent used for the brilliant ink composition may be water or an organic solvent, and is preferably water.

The metallic pigment content in the ink composition is preferably 0.1% to 10% by mass.

Examples of the organic solvent include polar solvents, such as alcohols (methyl alcohol, ethyl alcohol, propyl alcohol, butyl alcohol, isopropyl alcohol, fluoroalcohol, etc.), ketones (acetone, methyl ethyl ketone, cyclohexanone, etc.), carboxylic acid esters (methyl acetate, ethyl acetate, propyl acetate, butyl acetate, methyl propionate, ethyl propionate, etc.), and ethers (diethyl ether, dipropyl ether, tetrahydrofuran, dioxane, etc.).

Preferably, the organic solvent contains at least one alkylene glycol ether, which is liquid at room temperature and normal pressure.

Alkylene glycol ethers include ethylene glycol-based ethers and propylene glycol-based ethers, each containing an aliphatic group, such as methyl, n-propyl, isopropyl, n-butyl, isobutyl, hexyl, or 2-ethylhexyl, or allyl or phenyl having a double bond. Since alkylene glycol ethers are colorless and odorless and include the ether group and the hydroxy group in their molecules, they have both the characteristics as an alcohol and an ether and are liquid at room temperature. The alkylene glycol ether used in an embodiment of the invention may be a monoether prepared by substitution for only one of the hydroxy groups, or a diether prepared by substitution for both hydroxy groups. These types of alkylene glycol ether may be used in combination.

Preferably, the organic solvent is a mixture containing an alkylene glycol diether, an alkylene glycol monoether, and a lactone.

Exemplary alkylene glycol monoethers include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monoethyl ether, dipropylene glycol monomethyl ether, and dipropylene glycol monoethyl ether.

Exemplary alkylene glycol diethers include ethylene glycol dimethyl ether, ethylene glycol diethyl ether, ethylene glycol dibutyl ether, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

Exemplary lactones include γ-butyrolactone, δ-valerolactone, and ε-caprolactone.

By appropriately selecting the solvent, the resulting ink composition can be suitable for use in the method of embodiments of the invention.

Examples of the resin used in the brilliant ink composition include acrylic resin, styrene-acrylic resin, rosin-modified resin, terpene resin, polyester resin, polyamide resin, epoxy resin, vinyl chloride resin, vinyl chloride-vinyl acetate copolymer, cellulose-based resin (e.g., cellulose acetate butylate and hydroxypropyl cellulose), polyvinyl butyral, polyacrylic polyol, polyvinyl alcohol, and polyurethane.

Emulsion polymer particles may be used as the resin. Emulsion polymer refers to a dispersion of fine particles of polyurethane resin, acrylic resin or acrylic polyol resin stably dispersed in an organic solvent. Examples of the emulsion polymer using polyurethane include SANPRENE IB-501 and SANPRENE IB-F370 (produced by Sanyo Chemical Industries), W-6061 (produced by Mitsui Chemicals), and WBR-022U (produced by Taisei Fine Chemical). Examples of the emulsion polymer using acrylic polyol resin include N-2043-60MEX and N-2043-AF-1 (produced by Harima Chemicals).

The emulsion polymer can be added in an amount of 0.1% to 10% by mass to the brilliant ink composition in order to enhance the adhesion of the pigment to the recording medium. An excessively high content of the emulsion polymer reduces the printing stability, and excessively low content reduces the adhesion.

Preferably, the brilliant ink composition contains at least one selected from among glycerin, polyalkylene glycols and saccharides. The total content of glycerin, polyalkylene glycol and saccharide is preferably 0.1% to 10% by mass in the ink composition.

By appropriately selecting the resin, the resulting ink composition can be prevented from drying to cause clogging and thus can ensure stable ink ejection. Consequently, the resulting recorded matter has a high-quality image.

Polyalkylene glycol is a linear polymer containing a repetitive structure of ether bonds in the main chain, and can be produced by, for example, ring-opening polymerization of a cyclic ether.

Exemplary alkylene glycols include polymers, such as polyethylene glycol and polypropylene glycol, ethylene oxide-propylene oxide copolymers, and their derivatives. The copolymer may be random copolymer, block copolymer, graft copolymer, or alternating copolymer.

Preferred polyalkylene glycols may be expressed by the following formula:

HO—(CₙH₂ₙO)ₘ—H

In the formula, n represents an integer of 1 to 5, and m represents an integer of 1 to 100.

The (CₙH₂ₙO)ₘ of the formula may be a form expressed with a single n, or a form expressed by a combination of two or more numbers whose sum comes to n in the above range. For example, when n is 3, the (CₙH₂ₙO)ₘ is (C₃H₆O)ₘ; when n is the sum of 1 and 4, the (CₙH₂ₙO)ₘ is (CH₂O—C₄H₈O)ₘ. Also, the (CₙH₂ₙO)ₘ of the formula may be a form expressed with a single m, or a form expressed by a combination of two or more numbers whose sum comes to m in the above range. For example, when m is the sum of 20 and 40, the (CₙH₂ₙO)ₘ may be (CH₂O)₂₀—(C₂H₄O)₄₀; when m is the sum of 10 and 30, it may be (CH₂O)₁₀—(C₄H₈O)₃₀. The integers n and m may be arbitrarily combined in the above ranges.

Exemplary saccharides include monosaccharides, such as pentose, hexose, heptose, and octose; polysaccharides including disaccharides, trisaccharides, and tetrasaccharides; derivatives of those saccharides, such as sugar alcohols; reduced derivatives, such as deoxy acid; oxidized derivatives, such as aldonic acid and uronic acid; dehydro derivatives, such as glycoseen; amino acids; and thio sugars. Polysaccharide refers to saccharide in a broad sense, including compounds existing widely in the natural world, such as alginic acids, dextrin and cellulose.

Preferably, the brilliant ink composition contains an acetylene glycol-bases surfactant and/or a silicone-based surfactant. Preferably, 0.01% to 10% by mass of surfactant is added relative to the amount of the pigment in the ink composition.

By appropriately controlling the ink composition as above, the wettability to the recording medium can be improved to ensure rapid adhesion with the recording medium.

Preferred examples of the acetylene glycol-based surfactant include SURFYNOL 465 and SURFYNOL 104 (registered trademarks, produced by Air Products and Chemicals, Inc.) and OLFINE STG and OLFINE E1010 (registered trademarks, produced by Nissin Chemical Industry).

Preferred silicone-based surfactant may be a polyester-modified silicone or a polyether-modified silicone. For example, BYK-347, BYK-348, BYK-UV3500, BYK-UV3510, BYK-UV3530, and BYK-UV3570 (produced by BYK) can be used.

The brilliant ink composition can be prepared by a conventional procedure. For example, first, the metallic pigment, a dispersant and a solvent are mixed, and then the mixture is subjected to milling to prepare a pigment-dispersed liquid having desired properties with a ball mill, a bead mill, an ultrasonic mill, a jet mill, or the like. Subsequently, a binder resin, the solvent and other additives (such as a dispersing assistant and a viscosity modifier) are added to the pigment-dispersed liquid with stirring to yield a brilliant ink composition.

The composite pigment material may be subjected to ultrasonic treatment in a solvent to prepare a composite pigment-dispersed liquid, and then mixed with a desired ink solvent. Alternatively, the composite pigment material may be directly subjected to ultrasonic treatment in an ink solvent to yield a brilliant ink composition.

Although the properties of the resulting brilliant ink composition are not particularly limited, the surface tension is preferably 20 to 50 mN/m. If the surface tension is less than 20 mN/m, the ink composition spreads over the surface of the ink jet recording printer head or seeps from the head, and is thus difficult to eject in droplet form. If the surface tension is more than 50 mN/m, the ink composition is difficult to spread over the surface of the recording medium, and thus may not be able to achieve good printing.

### 1-2. White Ink Composition

The white ink composition used in an embodiment of the invention preferably contains at least one type of metal compounds and hollow resin particles as a white color material, and a resin component for fixing the color material.

The metal compound can be selected from among the conventionally used white pigments, such as metal oxides, barium sulfate, and calcium carbonate. Metal oxides include, but not limited to, titanium dioxide, zinc oxide, silica, alumina, and magnesium oxide. Preferably, titanium dioxide or alumina is used.

The metal compound content is preferably 1% to 20% by mass, more preferably 5% to 15% by mass. If the metal compound content is more than 20% by mass, the ink composition may, for example, clog the ink jet recording head to degrade the reliability. In contrast, if the metal compound content is less than 1% by mass, a sufficient whiteness may not be obtained.

Preferably, the metal compound has an average particle size (outer diameter) of 30 to 600 nm, more preferably 200 to 400 nm. If the outer diameter is more than 600 nm, the particles of the metal compound may sediment and lead to degraded dispersion stability, or may clog the ink jet recording head to degrade the reliability. In contrast, if the outer diameter is less than 30 nm, a sufficient whiteness may not be obtained.

The average particle size of the metal compound can be measured with a particle size distribution analyzer based on a laser diffraction/scattering method. A particle size distribution meter using dynamic light scattering (for example, Microtrack UPA manufactured by Nikkiso Co., Ltd.) may be used as the laser diffraction/scattering particle size distribution analyzer.

The hollow resin particles that may be used in an embodiment of the invention are each defined by an outer shell having a hollow interior. Preferably, the outer shell is made of a liquid-permeable resin. Consequently, if the hollow resin particle is present in an aqueous ink composition, the hollow interior is filled with an aqueous medium. Since the particle filled with an aqueous medium has substantially the same specific gravity as the external aqueous medium, the particle does not sink in the aqueous ink composition and, thus, can maintain the dispersion stability. Thus, the particle can enhance the storage stability and the ejection stability of the ink composition.

When a white ink composition containing such hollow particles is ejected onto a recording medium, such as paper, the aqueous medium in the particles is dried to form hollow interiors. The particles thus contain air. The hollow resin particles form a resin layer and an air layer having different refractive indices, and thus scatter light effectively to produce white color.

A known type can be used as hollow resin particles without particular limitation. For example, the hollow resin particle disclosed in U.S. Pat. No. 4,880,465 or Japanese Patent No. 3,562,754 can be suitably used.

The hollow resin particles preferably have an average particle size (outer diameter) of 0.2 to 1.0 μm, preferably 0.4 to 0.8 μm. If the outer diameter is more than 1 μm, the particles may sediment and lead to degraded dispersion stability, or may clog the ink jet recording head to degrade the reliability. In contrast, particles having an outer diameter of less than 0.2 μm tend to be insufficient in whiteness. In addition, it is suitable that the hollow resin particle has an inner diameter of about 0.1 to 0.8 μm.

The average particle size of the hollow resin particles can be measured with a particle size distribution analyzer based on a laser diffraction/scattering method. A particle size distribution meter using dynamic light scattering (for example, Microtrack UPA manufactured by Nikkiso Co., Ltd.) may be used as the laser diffraction/scattering particle size distribution analyzer.

Preferably, the hollow resin particle content in the ink composition is 5% to 20% by mass, more preferably 8% to 15% by mass. If the hollow resin particle content (solid content) is more than 20% by mass, the ink composition may, for example, clog the ink jet recording head to degrade the reliability. In contrast, if the hollow resin particle content is less than 5% by mass, a sufficient whiteness may not be obtained.

The hollow resin particles can be prepared by a known method without particular limitation. For example, the hollow resin particles can be prepared by so-called emulsion polymerization. In this method, for example, a vinyl monomer, a surfactant, a polymerization initiator and an aqueous disperse medium are stirred together in a nitrogen atmosphere while being heated, and thus an emulsion of hollow resin particles is prepared.

Exemplary vinyl monomers include nonionic monoethylene unsaturated monomers, such as styrene, vinyl toluene, ethylene, vinyl acetate, vinyl chloride, vinylidene chloride, acrylonitrile, (meth)acrylamide, and (meth)acrylic ester. Exemplary (meth)acrylic esters include methyl acrylate, methyl methacrylate, ethyl (meth)acrylate, butyl (meth)acrylate, 2-hydroxyethyl methacrylate, 2-ethylhexyl (meth)acrylate, benzyl (meth)acrylate, lauryl (meth)acrylate, oleyl (meth)acrylate, palmityl (meth)acrylate, and stearyl (meth)acrylate.

The vinyl monomer may be a bifunctional vinyl monomer. Examples of the bifunctional vinyl monomer include divinylbenzene, allyl methacrylate, ethylene glycol dimethacrylate, 1,3-butane-diol dimethacrylate, diethylene glycol dimethacrylate, and trimethylolpropane trimethacrylate. By polymerizing a foregoing monofunctional vinyl monomer and bifunctional vinyl monomer to form many cross-links, the resulting hollow resin particles can exhibit heat resistance, solvent resistance and dispersibility as well as light scattering characteristics.

The surfactant forms a molecular aggregate such as micelle in water. Examples of such a surfactant include anionic surfactants, nonionic surfactants, cationic surfactants, and amphoteric surfactants.

The polymerization initiator can be a known water-soluble compound, such as hydrogen peroxide or potassium persulfate.

The aqueous disperse medium can be water that may or may not contain a hydrophilic organic solvent.

Preferably, the white ink composition further contains a resin for fixing the metal compound and the hollow resin particles. Examples of such a fixing resin include acrylic resins (for example, Almatex produced by Mitsui Chemicals) and urethane resins (for example, WBR-022U produced by Taisei Fine Chemical).

The fixing resin content in the ink composition is preferably 0.5% to 10% by mass, more preferably 0.5% to 3% by mass.

Preferably, the white ink composition further contains at least one compound selected from the group consisting of alkanediols and glycol ethers. Alkanediols and glycol ethers can increase the wettability of the record surface of the recording medium to enhance the penetration of the ink.

Preferred alkanediols are 1,2-alkanediols having a carbon number in the range of 4 to 8, such as 1,2-butanediol, 1,2-pentanediol, 1,2-hexanediol, 1,2-heptanediol, and 1,2-octanediol. More preferably, 1,2-alkanediols having a carbon number of 6 to 8 are used, such as 1,2-hexanediol, 1,2-heptanediol, and 1,2-octanediol. These alkanediols can easily penetrate the recording medium.

Exemplary glycol ethers include lower alkyl ethers of polyhydric alcohols, such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, and tripropylene glycol monomethyl ether. In particular, triethylene glycol monobutyl ether can provide a higher record quality.

Preferably, the alkanediol and/or glycol ether content in the white ink composition is 1% to 20% by mass, more preferably 1% to 10% by mass.

Preferably, the white ink composition further contains an acetylene glycol-based surfactant or a polysiloxane-based surfactant. Acetylene glycol-based and polysiloxane-based surfactants can increase the wettability of the record surface of the recording medium to enhance the penetration of the resulting ink.

Examples of the acetylene glycol-based surfactant include 2,4,7,9-tetramethyl-5-decyne-4,7-diol, 3,6-dimethyl-4-octyne-3,6-diol, 3,5-dimethyl-1-hexyne-3-ol, and 2,4-dimethyl-5-hexyne-3-ol. A commercially available acetylene glycol-based surfactant may be used, such as OLFINE E1010, OLFINE STG and OLFINE Y (produced by Nissin Chemical Industry); and SURFYNOLs 104, 82, 465, 485, 485 and TG (produced by Air Products and Chemicals Inc.).

The polysiloxane-based surfactant may be a commercially available product, such as BYK-347 or BYK-348 (produced by BYK).

The white ink composition may contain other surfactants, such as anionic surfactant, nonionic surfactant, and amphoteric surfactant.

Preferably, the surfactant content in the white ink composition is 0.01% to 5% by mass, more preferably 0.1% to 0.5% by mass.

Preferably, the white ink composition further contains a tertiary amine. The tertiary amine can serve as a pH adjuster and can easily control the pH of the white ink composition.

For example, triethanolamine may be used as the tertiary amine.

Preferably, the tertiary amine content in the white ink composition is 0.01% to 10% by mass, more preferably 0.1% to 2% by mass.

Preferably, the white ink composition further contains water as the solvent. Preferably, the water is pure water or ultrapure water, such as ion exchanged water, ultrafiltered water, reverse osmotic water, or distilled water. Preferably, the water is sterilized by irradiation with UV light or by adding hydrogen peroxide. Such water prevents occurrence of molds and bacteria over the long term.

The white ink composition may further contain other additives including a fixing agent such as water-soluble rosin, an antifungal agent or preservative such as sodium benzoate, an antioxidant or ultraviolet light adsorbent such as an allophanate, a chelating agent, and an oxygen absorbent, if necessary. These additives may be used singly or in combination.

The white ink composition can be prepared in the same manner as known pigment inks, using a known apparatus, such as ball mill, sand mill, attritor, basket mill or roll mill. For preparation, it is preferable that coarse particles be removed through a membrane filter or a mesh filter.

### 2. Process Color Ink Composition

The process color ink composition will now be described, which is used for forming color images in the second step of the image recording method according to the present embodiment of the invention.

The process color ink composition mentioned herein refers to a color ink composition showing a color other than white, and contains a color material of cyan (C), magenta (M), Yellow (Y), or black (K). Any process color ink composition may be used without particular limitation, and a commercially available process color ink composition may be used.

The color material may be a pigment or a dye. For example, a color ink composition disclosed in JP-A-2003-192963, JP-A-2005-23253, JP-A-9-3380, or JP-A-2004-51776 may be suitable.

The “color” mentioned herein covers the entire region where colors appear, not referring to a color in a specific color region. In other words, the color can be any position in chromatic coordinates except a position of L*=100, a*=0 and b*=0 (ideal white) in L*a*b* coordinates.

Preferably, the process color ink composition contains water as the main solvent.

### 3. Image Recording Method

### 3-1. Ink Jet Recording Method

In the image recording method according to an embodiment of the invention, the undercoat layer and the color image can be formed by an ink jet recording method. However, any other analog printing may be applied, such as offset printing, flexography, or gravure printing.

The ink jet recording method forms images of the above-described ink compositions by operating an ink jet head so as to eject droplets of ink compositions onto a recording medium.

The ink composition may be ejected by the following techniques.

A first technique is electrostatic suction. In this technique, a strong electric field is applied between a nozzle and an acceleration electrode disposed in front of the nozzle. Ink droplets are continuously ejected for recording from the nozzle, and a printing information signal is applied to deflecting electrodes while the ink droplets fly between the deflecting electrodes, or ink droplets may be ejected according to printing information without deflecting the ink droplets.

A second technique is a method for forcibly ejecting ink droplets by applying a pressure to the ink composition with a small pump and mechanically vibrating the nozzle with a quartz resonator. The ejected ink droplets are charged simultaneously with the ejection of the ink, and recording is performed by applying printing information to the deflecting electrodes while the ink droplets fly between the deflecting electrodes.

A third technique uses a piezoelectric element. A pressure and printing information are simultaneously applied to the ink composition with the piezoelectric element, thereby ejecting ink droplets for recording.

In another technique, the volume of the ink composition may be rapidly expanded by thermal energy. The ink is bubbled by heating with a small electrode according to the printing information, and is thus ejected for recording.

Although any technique may be applied to the ink jet recording performed in embodiments of the invention, it is preferable that the ink composition be ejected without being heated, from the viewpoint of enabling high-speed printing. Hence, the first to third techniques are preferred.

### 3-2. Drying

In the image recording method of the present embodiment of the invention, the undercoat layer preferably is dried to control the volatile component content immediately after the first step. Any technique may be used for drying. For example, the medium may be heated by contact with a heat source. Alternatively, the undercoat layer may be dried in a non-contact manner by being irradiated with infrared rays or microwaves (having the maximum peak at a wavelength of about 2.450 MHz) or by blowing hot air to the undercoat layer. The heating temperature can be 30 to 80° C., such as 40 to 60° C., depending on the type of the medium and the pigment of the undercoat layer. The undercoat layer may be dried by blowing air with a fan, or by natural air drying.

In order to further reduce ink bleeding, preferably, drying step may be performed in the same manner as above after the second step, in which a color image is formed of a process color ink on the undercoat layer.

In the image recording method of an embodiment of the invention, the first step may be performed by the page with a recording apparatus first, and second step may be performed on the sheet of the page fed again to the recording apparatus. Alternatively, both the first step and the second step may be performed for one sheet feeding, that is, may be performed between when the medium is fed to the recording apparatus and when the medium is ejected from the recording apparatus. In the latter case, it is preferable that the medium be heated with a heater or the like provided to the recording apparatus, in the course of or after forming the undercoat layer in the first step. Since the drying time is reduced by heating, the heating may be performed, for example, while a carriage on which the recording head is disposed is moved for a subsequent main scanning, or while the medium is transported.

How the heater or the like for heating the medium is provided to the recording apparatus is described in, for example, JP-A-10-86353.

### 4. Medium

The medium used in embodiments of the invention refers to an ink-non-absorbent or ink-low-absorbent recording medium. The ink-non-absorbent or ink-low-absorbent recording medium refers to a recording medium having no ink-absorbent layer or an insufficient ink-absorbent layer. More specifically, the ink-non-absorbent or ink-low-absorbent recording medium exhibits a water absorption of 10 mL/m² or less for a period of 30 ms^{1/2} from the beginning of contact with water, measured by Bristow's method. Bristow's method is broadly used for measuring liquid absorption for a short time, and Japan Technical Association of the Pulp and Paper Industry (JAPAN TAPPI) has officially adopted this method. Details of this method are specified in Standard No. 51 of “JAPAN TAPPI Kami Pulp Shiken Hou 2000-nen Ban” (JAPAN TAPPI Pulp and Paper Test Methods, edited in 2000). The ink-non-absorbent recording medium may be a medium, such as a plastic film or paper, not surface-treated for ink jet printing (not having an ink-absorbent layer) whose surface is coated with a plastic or to which a plastic film is bonded. The plastic mentioned herein may be, for example, polyvinyl chloride, polyethylene terephthalate, polycarbonate, polystyrene, polyurethane, polyethylene, or polypropylene. The ink-non-absorbent medium may be coated with a metal or glass. The ink-low-absorbent recording medium may be art paper, coated paper, or matte paper.

### Recorded Matter

The recorded matter according to embodiments of the invention includes an image recorded by the image recording method according to an embodiment of the invention, preferably by the above-described ink jet recording method. Since the recorded matter is produced by the image recording method of an embodiment of the invention, ink bleeding does not occur in the recorded color image, and thus the color image is of high quality.

### Image Recording System

An image recording system according to an embodiment of the invention includes an undercoat layer-forming unit that forms an undercoat layer of an undercoat-forming ink composition on a medium, and a color image layer-forming unit that forms an color image layer of a process color ink composition on the undercoat layer in a state where the undercoat layer contains 5% to 50% by mass of remaining volatile component. The undercoat layer-forming unit and the color image layer-forming unit may be combined into one body in the image recording system, or they each may function as an independent apparatus (for example, an ink jet recording apparatus forms the undercoat layer, and another ink jet recording apparatus forms the color image layer).

### EXAMPLES

The invention will further be described in detail with reference to Examples, but the invention is not limited to the following Examples.

### (1) Preparation of White Ink Composition

A white ink composition (Ink 1) containing a metal compound as a color material was prepared according to the composition shown in Table 1. The values in Table 1 are represented in percent by mass.

TABLE 1

| | Solid content | Content in Ink 1 |
|---|---|---|
| Constituent | (%) | (mass %) |
| Metal oxide (titanium dioxide) | 15.0 | 66.6 |
| NanoTek (R) Slurry | | |
| urethane resin | 30.0 | 5 |
| Propylene crycol | — | 15 |
| 1,2-hexanediol | — | 3 |
| Trimethylamine | — | 0.5 |
| BYK-348 | — | 0.5 |
| Ion exchanged water | — | Balance |
| Total | — | 100 |

Commercially available NanoTek (R) Slurry (produced by C. I. Kasei) shown in Table 1 was used as the metal compound. NanoTek (R) Slurry contains 15 of titanium dioxide having an average particle size of 36 nm as a solid content.

BYK-348 (produced by BYK) is a polysiloxane-based surfactant.

WBR-022U (produced by Taisei Fine Chemical) was used as the urethane resin.

### (2) Printing Tests

### (2-1) Printing Test 1

For the printing test, two ink jet printers PX-A650 (manufactured by Seiko Epson) were used. One of the printers was used for ejecting the white ink composition (white ink ejecting printer) and the other was used for ejecting process color ink compositions (color ink-ejecting printer). For the white ink-ejecting printer, an ink cartridge normally used for black ink was filled with the white ink composition and was set in the position where normally the black ink cartridge is set. The color ink-ejecting printer used maker's specified aqueous ink cartridges (ICC42, ICM42, ICY42 and ICBK31) respectively containing cyan (C), magenta (M), yellow (Y) and black (K) color materials, as they were.

PET 100(A) PL core 11BL manufactured by Lintec Corporation was used as the non-absorbent medium. PET 100(A) PL core 11BL is a polyethylene terephthalate film not having an absorbent layer, such as a coating for ink jet printing. This film was cut into A4 sheets for the test.

First, the white ink composition was applied over the surface of the non-absorbent medium to form an undercoat layer using the white ink-ejecting printer. The resolution was 1440×720 dpi.

Subsequently, the undercoat layer was air-dried until the content of the volatile content remaining in the undercoat layer was reduced to a predetermined value, and a color image was formed using the color ink-ejecting printer. The resolution was 1440×720 dpi. The content of remaining volatile component was calculated from the weight of the ink deposited on the print surface.

The resulting color image was checked for bleeding by visual observation. The evaluation criteria were as follows. The results are shown in Table 2.

A: No bleeding was observed in the color image.

B: Slight bleeding was observed particularly at a boundary between black and another color.

C: Nonuniformity or bleeding was observed in a solid portion of the color image, but is acceptable in practice.

D: Unacceptable serious bleeding was observed.

TABLE 2

| Remaining volatile | | |
|---|---|---|
| content (mass %) | Evaluation | Remark |
| 55 | D | Comparative Example |
| 48 | C | Example |
| 35 | B | Example |
| 28 | B | Example |
| 22 | A | Example |
| 15 | A | Example |
| 9 | B | Example |
| 6 | C | Example |
| 1 | D | Comparative Example |

Table 2 shows that color images formed in the state where the undercoat layer contains 5% to 50% by mass of remaining volatile component had good quality with bleeding reduced. Particularly when the remaining volatile content was 10% to 20% by mass, bleeding was notably reduced.

On the other hand, when the remaining volatile content was outside the range of 5% to 50% by mass, bleeding occurred in the color image. Contrary to expectations, even though the remaining volatile content was low, that is, even though the undercoat layer was sufficiently dried, bleeding occurred in the color image formed in a state where the remaining volatile content was outside the above range. Although the undercoat layer containing about 5% by mass of remaining volatile component can be in a state where the volatile component has almost been vaporized, the white ink composition of the undercoat layer flowed easily by finger contact. In contrast, the undercoat layer containing about 50% by mass of remaining volatile component was not almost dried.

### (2-2) Printing Test 2

Images subjected to Printing Test 2 were formed by the procedure described below with reference to drawings.

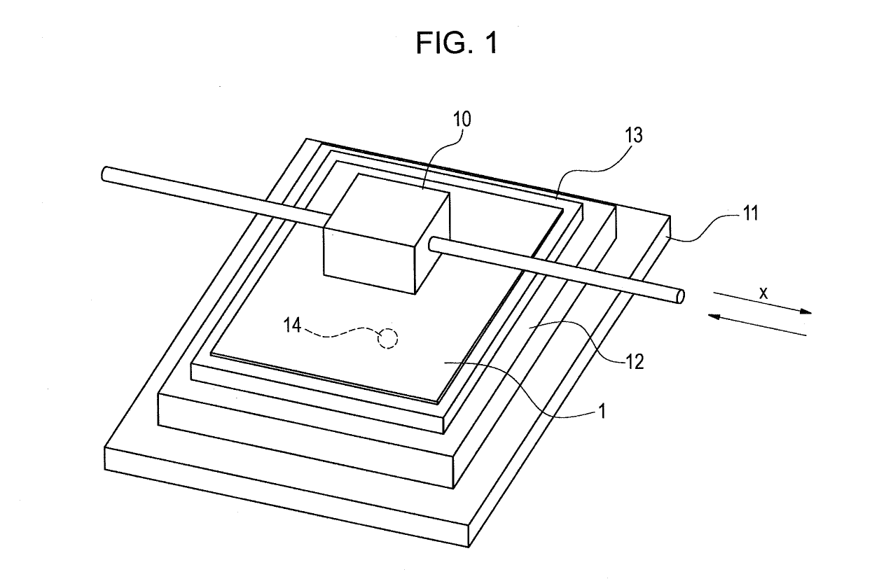

A stage 11 on which a medium 1 is secured was disposed opposing a print head mechanism 10 in an ink jet printer PX-A650 (manufactured by Seiko Epson), and, thus, an evaluation test apparatus was prepared. FIG. 1 is a schematic fragmentary view of the evaluation test apparatus. An electronic balance capable 12 of weighing the medium 1 and a heater 13 capable of heating the medium 1 are disposed on the stage 11. The heater 13 is controlled by a temperature sensor 14 so as to control the medium 1 to a predetermined temperature. The same white ink, process color inks and medium 1 as those in Printing Test 1 were used. The print head mechanism 10 includes a recording head from which inks are ejected and a carriage. The recording head is reciprocally scanned in the main scanning direction X.

In Printing Test 2, the medium temperature was controlled to 60° C. during printing.

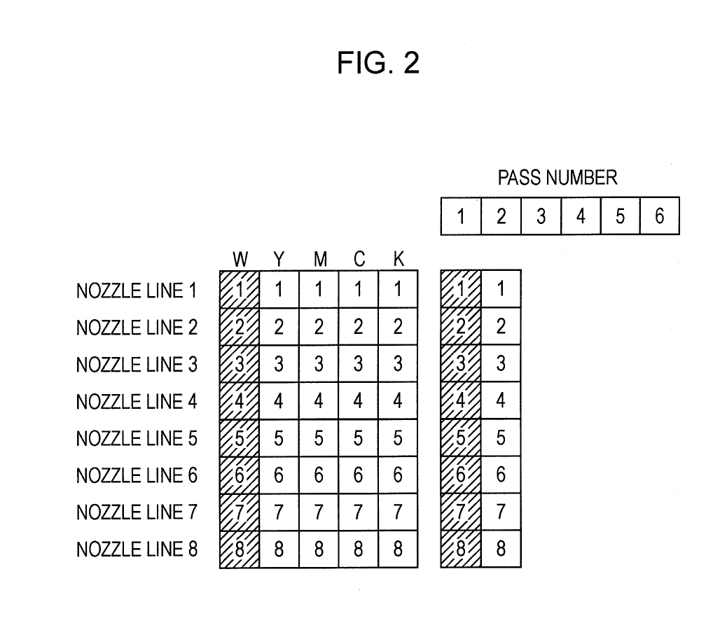

The recording head was scanned (passed) for a first recording in one direction of the lateral directions shown in FIG. 1 (in the main scanning directions X) to form an undercoat layer of the white ink on the medium 1. Subsequently, another pass (second recording) is performed for ejecting only process color inks onto the undercoat layer. In this instance, nozzles are arranged using all nozzle lines as shown in FIG. 2 so that the white ink and the process color inks are alternately printed by passes. The intervals between the nozzles in the nozzle line are 180 dpi, and the recording resolution in the sub-scanning direction is 180 dpi.

The degree of bleeding of the process inks was evaluated according to the time retained for shifting the carriage for the second pass from the first pass. The results are shown in Table 3. The evaluation criteria were the same as in Printing Test 1. The time shown in Table 3 refers to the elapsed time after the white ink has been ejected, and the remaining volatile content is the average of 20 repetitive measurements.

The remaining volatile content was calculated from the mass of the medium 1 immediately after the first pass and the mass of the medium 1 after a predetermined time elapsed. Printing Test 1 may be performed such that the remaining volatile content is measured at room temperature, with the heater 13 off without heating the medium 1 to dry. If the medium temperature is set to room temperature, the time retained for shifting is increased.

TABLE 3

| Time (s) | 0.7 | 1.4 | 2.3 | 3 | 4 | 5 | 6 | 7 | 8 |
|---|---|---|---|---|---|---|---|---|---|
| Remaining | 65.0 | 43.8 | 21.3 | 15.4 | 10.1 | 7.9 | 5.1 | 3.9 | 2.5 |
| volatile | | | | | | | | | |
| content (%) | | | | | | | | | |
| Evaluation | D | B | A | A | A | B | C | D | D |

### (2-3) Printing Test 3

Images subjected to Printing Test 3 were formed by the procedure described below with reference to drawings.

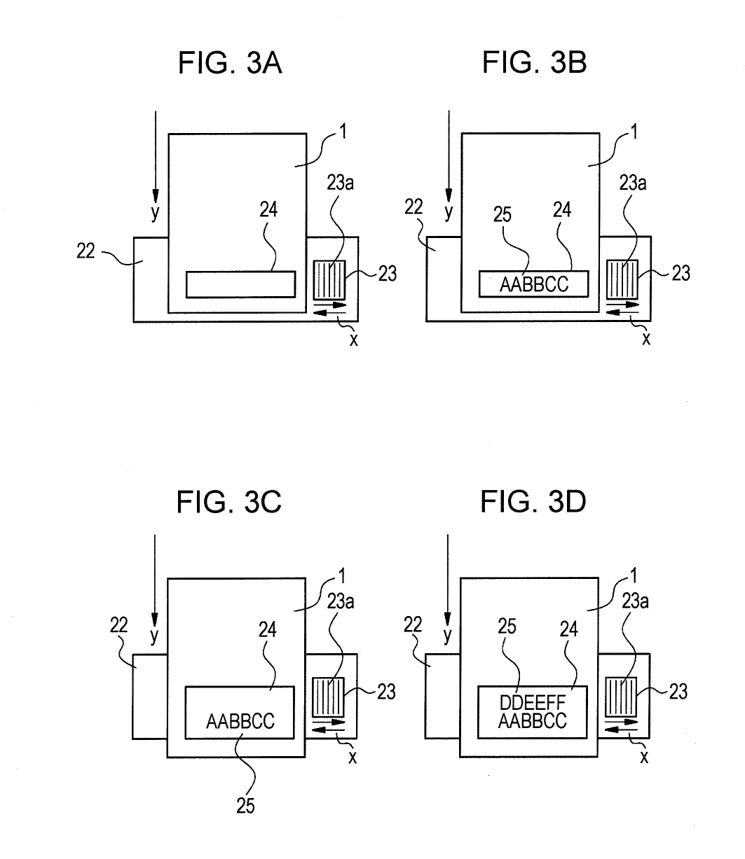

FIGS. 3A to 3D are schematic diagrams illustrating steps of the image recording method used in Printing Test 3.

In Printing Test 3, a heater 22 having a width larger than the width of the medium 1 was disposed on a platen acting as the transport path opposing the recording head 23 of an ink jet printer PX-A650 (manufactured by Seiko Epson), as shown in FIGS. 3A to 3D, so that the entire rear surface of the medium 1 was heated to 60° C.

The recording head 23 had nozzle lines 23a each defined by nozzles aligned in the sub-scanning direction y, and inks were arranged such that the same color aligns in the sub-scanning direction y.

First, the medium 1 was transported in the sub-scanning direction y and stopped at the platen having the heater 22. The carriage on which the recording head 23 was disposed passed in one of the lateral directions shown in the figures (in the main scanning directions x) to form an undercoat layer 24 of the white ink on the medium 1 (first recording, FIG. 3A).

Subsequently, the carriage was scanned to pass to eject the process color ink compositions with the medium 1 stopped, thus forming a color image layer 25 (second recording, FIG. 3B). In this test, letters were recorded as the color image layer 25. Then, the medium 1 was moved in the sub-scanning direction y to prepare for the third recording (FIG. 3C).

Then, the first recording and the second recording were repeated (to perform third recording (FIG. 3C) and fourth recording (FIG. 3D)), and the medium 1 was ejected from the printer.

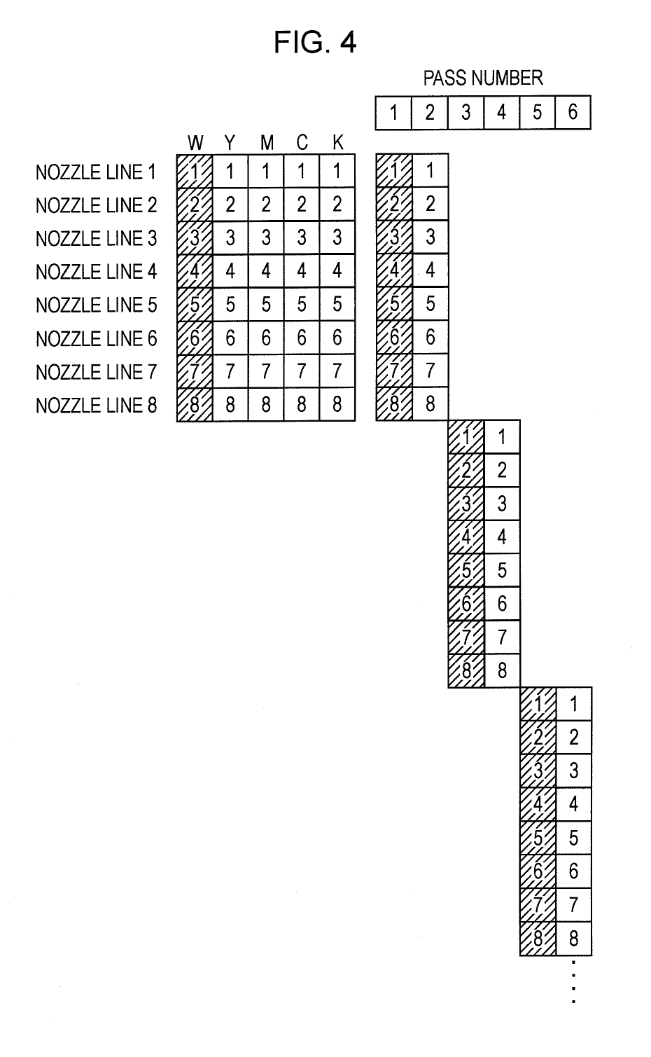

Specifically, nozzles were arranged using all nozzle lines 23a as shown in FIG. 4 so that the white ink and the process color inks were alternately printed by passes. More specifically, the white ink nozzle (W, hatched portion) was located at the most upstream position of each of nozzle lines 1 to 8 (nozzle lines 23a in FIGS. 3A to 3D) in the main scanning direction, and the process color ink nozzles (cyan ink nozzle C, magenta ink nozzle M, Yellow ink nozzle Y, and black ink nozzle K) were located downstream from the white ink nozzle W in the main scanning direction in each nozzle line. The intervals between the nozzles in the nozzle line were 180 dpi, and the recording resolution in the sub-scanning direction was 180 dpi. Thus, the sequence was repeated which includes a pass for ejecting only the white ink, a subsequent pass for ejecting the process color inks onto the undercoat layer formed of the white ink by the foregoing pass, and then the transport of the recording material in the sub-scanning direction y.

From the results (Table 3) of Printing Test 2, the time interval until a color ink is ejected over the same pixel from when the white ink has been ejected to a pixel was set at 4 seconds per pass, and the temperature of the medium 1 was set to 60° C. As a result, a fine and precise image were formed under those conditions.

The above result suggests that by providing a heater or the like to the recording apparatus to reduce the time for drying the white ink of the undercoat layer, the content of volatile component remaining in the undercoat layer can be controlled by retaining only a time period for which the carriage is shifted for another pass.

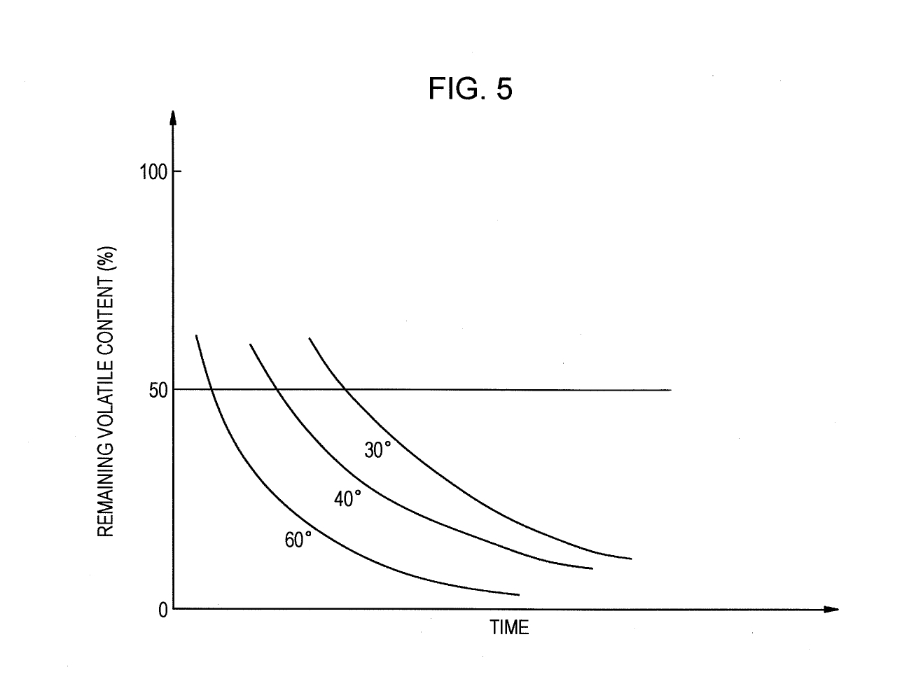

In an embodiment of the invention, a recording head ejecting a white ink may be disposed upstream in the sub-scanning direction, and another recording head ejecting process color inks may be disposed downstream from the white ink head, as disclosed in JP-A-2000-141708. Thus, the time interval until a color ink is ejected over the white ink in the same pixel from when the white ink has been ejected to a pixel can be set to a time period for which at least one pass of main scanning is performed, so that the drying time is increased. A dead time may be given between passes of main scanning. Thus, the remaining volatile content can be appropriately controlled when the temperature is set to lower than 60° C. and the time interval is set longer than that in the Printing test. In contrast, if the temperature is set higher, the remaining volatile content can be appropriately controlled by reducing the time interval. FIG. 5 shows drying temperature curves with the remaining volatile content and time, measured using the evaluation test apparatus.

What is claimed is:

1. An image recording method comprising: forming an undercoat layer of an undercoat-forming ink composition containing a volatile component on a medium, and forming a color image layer of a process color ink composition on the undercoat layer in a state where the content of the volatile component remaining in the undercoat layer is 5% to 50% by mass.

2. The image recording method according to claim 1, further comprising drying the undercoat layer between forming the undercoat layer and forming the color image layer.

3. The image recording method according to claim 1, wherein the undercoat layer-forming ink composition is a brilliant ink composition containing a metallic pigment or a white ink composition containing a white color material selected from among metal compounds and hollow resin particles.

4. The image recording method according to claim 1, wherein the undercoat layer-forming ink composition and the process color ink composition each contain water as a main solvent.

5. The image recording method according to claim 1, wherein the undercoat layer-forming ink composition contains 3% to 20% by mass of solid content.

6. The image recording method according to claim 1, wherein the color image layer is formed on the undercoat layer in a state where the content of the remaining volatile component is 10% to 25% by mass.

7. The image recording method according to claim 1, wherein further comprising drying the undercoat layer and the color image layer after forming the color image layer.

8. The image recording method according to claim 1, wherein the medium is non-absorbent or low-absorbent of inks.

9. The image recording method according to claim 1, wherein the image recording method is performed by recording apparatus including a recording head including a nozzle line defined by a plurality of nozzles, and a transport member that transports the medium in a sub-scanning direction intersecting a main scanning direction, wherein the undercoat layer-forming ink composition and the process color ink composition are ejected onto the medium from the recording head in a state where the recording head opposes the medium, and the recording head ejects the process color ink composition onto the medium a predetermined time after the undercoat layer-forming ink composition is ejected.

10. The image recording method according to claim 9, wherein the undercoat layer-forming ink composition is ejected more upstream than the process color ink composition in the direction in which the medium is transported.

11. The image recording method according to claim 9, wherein the recording apparatus further includes a carriage that has the recording head thereon and reciprocally moves in the main scanning direction, and wherein the undercoat layer-forming ink composition is ejected from the recording head onto the medium stopped being transported while the carriage is reciprocally moving, and then the process color ink composition is ejected from the recording head onto the medium while the carriage is reciprocally moving.

12. The image recording method according to claim 9, wherein the recording apparatus further includes a heater that heats the medium, and wherein the medium is heated after forming the undercoat layer.

13. The image recording method according to claim 1, wherein the method is performed by an ink jet recording method.

14. A recorded matter produced by the image recording method as set forth in claim 1.

15. An image recording system comprising: an undercoat layer-forming unit that forms an undercoat layer of an undercoat-forming ink composition containing a volatile component on a medium; and a color image layer-forming unit that forms an color image layer of a process color ink composition on the undercoat layer in a state where the content of the volatile component remaining in the undercoat layer is 5% to 50% by mass.
